(19) United States
(12) Patent Application Publication
(10) Pub. No.: US 2016/0174076 A1
(43) Pub. Date: Jun. 16, 2016

(54) MATCHING DEVICE AND METHOD FOR ELECTRONIC ATOMIZATION DEVICE BASED ON MOBILE TERMINAL

(71) Applicant: Jianyong Wu, Shenzhen (CN)

(72) Inventor: Jianyong Wu, Shenzhen (CN)

(73) Assignee: SHENZHEN JIESHIBO TECHNOLOGY CO., LTD., Shenzhen, Guangdong (CN)

(21) Appl. No.: 14/404,011

(22) PCT Filed: Aug. 15, 2014
(86) PCT No.: PCT/CN2014/084522

§ 371 Date: Nov. 26, 2014

(51) Int. Cl. H04W 12/12; H04W 4/00

(52) U.S. Cl. CPC H04W 12/12; H04W 4/008; H04W 88/02

(57) ABSTRACT

Disclosed are a matching device and a matching method for electronic atomization device based on mobile terminal. The device includes a Bluetooth control module, an information reading module, an information transmission module and a comparing and matching module. The method includes steps of: building a Bluetooth connection between battery and mobile terminal; controlling the battery to read identification information of identification chip of atomizer; sending the identification information to the mobile terminal via Bluetooth and then carrying out a match by comparing the atomizer identification information and original identification information; and carrying out a match by comparing the identification information and original identification information. By connecting the electronic atomization device with mobile terminal via Bluetooth and by means of powerful computing ability of the mobile terminal, match between the battery and atomizer of electronic atomization device can be achieved on the mobile terminal directly.

### FIELD OF THE INVENTION

The present invention relates to electronic atomization device and, in particular, it concerns a matching device and method for electronic atomization device based on mobile terminal.

### BACKGROUND OF THE INVENTION

Electronic atomization device, also called electronic cigarette, atomization tobacco with low temperature, is mainly used for reducing harm brought by smoking traditional cigarette. Its appearance and taste is similar to cigarette and it has more flavors than even normal cigarette do. It also can create a cloud, a taste and a feel that resembles cigarette. The electronic atomization device, which is composed of battery assembly and atomizer, is an imitative cigarette, and flavor components therein can be atomized into gas by atomization so that user can inhale it directly. The flavor components includes tobacco liquid, tobacco shred, tobacco powder, tobacco paste, fragrant slice, fragrant bar, liquid tobacco and so on.

For the electronic atomization device, after being used for some time, its atomizer needs to be replaced with a new one, so as to prevent generation of the carbon deposition and hazardous substance. There are appeared more and more counterfeit atomizers on the market and it is difficult to distinguish the true one from the counterfeit ones for consumers. When consumer needs to change an atomizer but he/she buys a counterfeit one, it will not only damage the benefit of the consumer itself, but also have bad effect on brand reputation for the manufacturer of the atomizer.

In order to make the counterfeit atomizer cannot match the authentic battery, some manufacturers provide functions of recognition and match between the atomizer and battery. Some electronic cigarettes are provided with identification information stored in their atomizers and the identification information will be sent to the battery by the atomizer and then identification and match processing will be carried out directly by the battery. These electronic atomization devices have a problem that both of the atomizer and battery thereof have higher costs. Thus, it is disadvantageous for market promotion of the electronic atomization device.

### SUMMARY OF THE INVENTION

An object of the present invention is to overcome the defects of the prior art by providing a matching device and method for electronic atomization device based on mobile terminal, which can achieve a function of match between battery and atomizer of the electronic atomization device at a lower cost.

To achieve the above object, there are provided following technical solutions:

An matching device for electronic atomization device based on mobile terminal, includes following modules:

A Bluetooth control module, provided for building a Bluetooth connection between battery and mobile terminal;

An information reading module, provided for controlling the battery to read identification information of identification chip of atomizer;

An information transmission module, provided for sending the identification information to the mobile terminal via Bluetooth; and

A comparing and matching module, provided for carrying out a match by comparing the identification information and original identification information.

Preferably, the device further includes a match control module, which is provided for controlling the battery to wait for use instruction from user so as to supply power to the atomizer when the match is successful.

Preferably, the device further includes a match warning module, which is provided for giving user a warning that the match is unsuccessful and controlling the battery not to supply power to the atomizer when failing to match.

Preferably, the comparing and matching module is provided for firstly carrying out a match by comparing the identification information and the original identification information stored in memory of the mobile terminal, and then carrying out a match by comparing the identification information and the original identification information stored in cloud server if the match is unsuccessful.

Preferably, the device further includes an information storage module, which is provided for sending the information of frequency, time and date of use of atomizer, which is taken as use information of atomizer, in real time to the mobile terminal to be stored therein, after the match is successful.

Preferably, the storage module is further used for sending the use information to cloud server as a backup via wireless module.

In addition, there is provided a matching method for electronic atomization device based on mobile terminal, which includes following steps:

S1: building a Bluetooth connection between battery and mobile terminal;

S2: reading identification information of identification chip of the atomizer via the battery;

S3: sending the identification information to the mobile terminal via Bluetooth; and

S4: carrying out a match by comparing the identification information and original identification information.

Preferably, the step S4 further includes a step of: controlling the battery to wait for use instruction from user so as to supply power to the atomizer when the match is successful.

Preferably, the step S4 further includes a step of: giving user a warning that the match is unsuccessful and controlling the battery not to supply power to the atomizer when the match is unsuccessful.

Preferably, the step S4 includes steps of: firstly carrying out a match by comparing the identification information and the original identification information stored in memory of the mobile terminal, if the match is unsuccessful, carrying out a match by comparing the identification information and the original identification information stored in cloud server.

Preferably, there is provided a following step after step S4:

S5: sending use information of atomizer in real time to the mobile terminal to be stored therein

Preferably, the step S5 further includes a step of: sending the use information to cloud server as a backup via wireless module, simultaneously.

Compared with the prior art, the present invention has beneficial effects as follows:

(1) As disclosed in the present invention, electronic atomization device is connected with mobile terminal via Bluetooth, by means of powerful computing ability of the mobile terminal, match between the battery and atomizer of electronic atomization device can be achieved on the mobile terminal directly, thereby reducing manufacturing cost and it is advantageous for market promotion of the electronic atomization device. And the condition about matching can be shown on the mobile terminal so as to facilitate understanding of the situation for user.

(2) The use information of electronic atomization device can be collected to constitute a database, so as to facilitate follow-up statistics and analysis for the database, thereby the condition such as habit of user can be understood easily, additionally, the user can check the information on the mobile terminal and control the frequency and habit of use easily.

### BRIEF DESCRIPTION OF THE DRAWINGS

FIG. 1 is a system block diagram of a matching device according to the present invention; and

FIG. 2 is a flow chart of a matching method according to the present invention.

### DETAILED DESCRIPTION OF ILLUSTRATED EMBODIMENTS

For understanding the technical content of the present invention more sufficiently, now combine specific embodiments to introduce and illustrate the technical solution of the present invention as follows.

### The First Embodiment

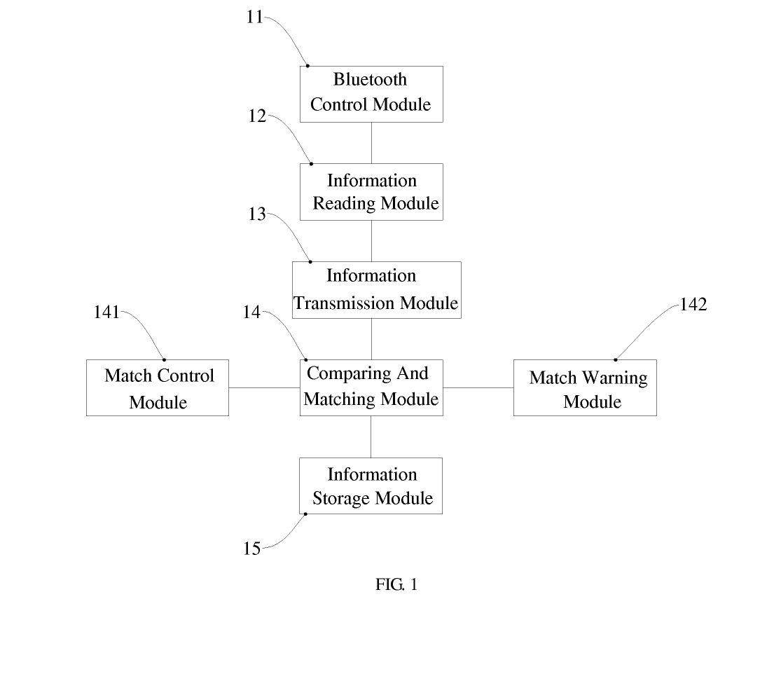

The matching device for electronic atomization device based on mobile terminal according to the first embodiment, of which a system block diagram is shown in FIG. 1, includes following modules:

A Bluetooth control module 11, is provided for building a Bluetooth connection between battery and mobile terminal, the Bluetooth control module 11 firstly making the Bluetooth of the mobile terminal open, and then searching Bluetooth signal of the battery and trying to connect with the battery.

An information reading module 12, is provided for controlling the battery to read identification information of identification chip of the atomizer. The identification chip is provided within the atomizer when the atomizer is delivered and the identification chip can be a common ID chip. The identification chip of each atomizer has a serial number, which is uniquely corresponding to one atomizer, thus, such a serial number is the identification information of the identification chip. In other embodiments, the identification chip can be replaced by a memory chip and a unique serial number is written into the memory chip; and the memory chip can be a re-writable memory chip and also can be a write-once memory chip.

An information transmission module 13, is provided for sending the identification information to the mobile terminal via Bluetooth. After the battery reads the identification information successfully, the information transmission module 13 controls the battery to send the identification information to the mobile terminal via Bluetooth.

A comparing and matching module 14, is provided for carrying out a match by comparing the atomizer identification information and original identification information. After the mobile terminal receives the identification information, the comparing and matching module 14 carries out a match by comparing the atomizer identification information and original identification information with the purpose of testing whether the atomizer is an original factory product. The comparing and matching module 14 firstly carries out a match by comparing the atomizer identification information and the original identification information stored in the memory of the mobile terminal, and if the match is not a success, then carries out a match by comparing the identification information and the original identification information stored in cloud server.

A match control module 141, is provided for controlling the battery to wait for use instruction from user so as to supply power to the atomizer when the match is successful. If the match is successful, the match control module 141 will send an instruction that the match is successful to the battery and after receiving the instruction, the battery will wait for use instruction from user thereby supplying power to the atomizer. At this point, the user can smoke atomizer directly. The starting of the atomizer can be controlled by airflow sensor provided in the atomizer or controlled by switch button provided on the battery, and when using, the user needs to press the switch button for normal use.

A match warning module 142, is provided for giving a warning to user that the match is unsuccessful when failing to match. If failing to match, the match warning module 142 will give a warning to user that the match is unsuccessful and send an instruction of match failure to the battery, and the battery will not supply power to the atomizer after receiving the instruction of match failure. On this condition, no matter the user how to operate the atomizer, the atomizer receives no power supply from the battery, thus the atomizer can not work. The warning given to user that the authentication is unsuccessful can be achieved in many ways, such as by sending an instruction to make the battery twinkle, providing pop-up dialogs on the mobile terminal and making the screen blink and so on.

An information storage module 15, is provided for sending use information of atomizer in real time to the mobile terminal to be stored therein and sending it to the cloud server as a backup via wireless module, simultaneously. The use information of atomizer includes the information of frequency of use, duration of use, power, time, date, resistance value of heating wire and taste of the atomizer and so on.

### The Second Embodiment

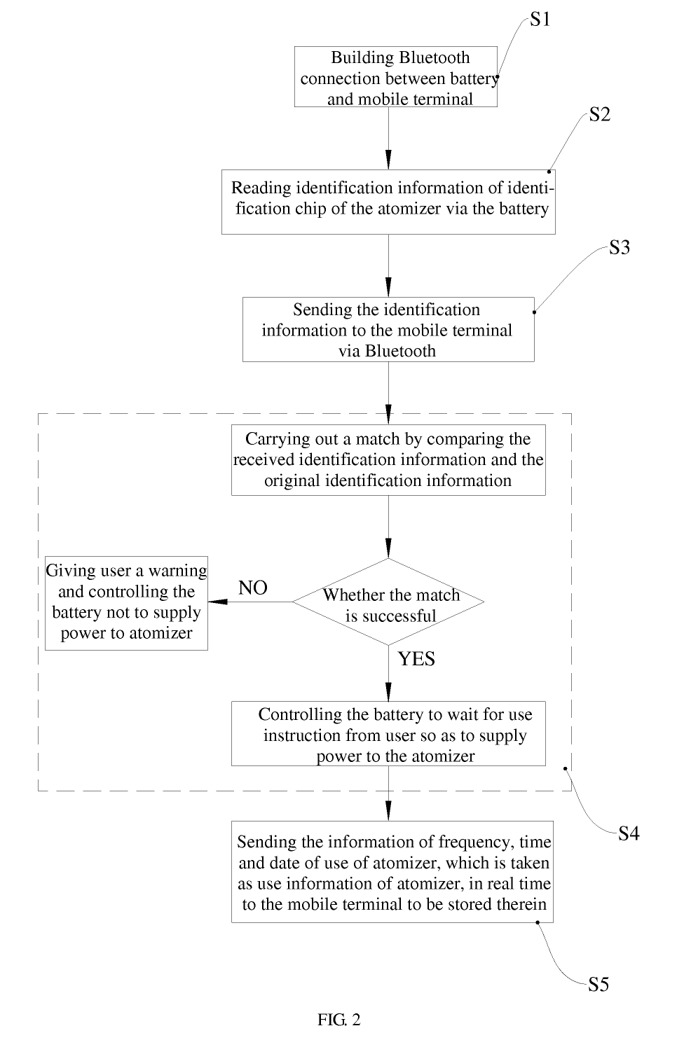

The matching method for electronic atomization device based on mobile terminal, of which a flowchart diagram is shown in FIG. 2, includes following steps:

Step S1: building a Bluetooth connection between battery and mobile terminal, the step S1 includes steps of: opening Bluetooth of the mobile terminal and then searching Bluetooth signal of the battery and trying to connect with the battery.

Step S2: reading identification information of identification chip of the atomizer via the battery; the identification chip is provided within the atomizer when the atomizer is delivered and the identification chip can be a common ID chip. The identification chip of each atomizer has a serial number, which is uniquely corresponding to one atomizer, thus, such a serial number is the identification information of the identification chip. In other embodiments, the identification chip can be replaced by a memory chip and a unique serial number is written into the memory chip; and the memory chip can be a re-writable memory chip and also can be a write-once memory chip.

Step S3: sending the identification information to the mobile terminal via Bluetooth; specifically, after the battery reading the identification information successfully, the battery will send the identification information to the mobile terminal via Bluetooth.

Step S4: carrying out a match by comparing the identification information that has been received and original identification information. After receiving the identification information, the mobile terminal carries out a match by comparing the atomizer identification information and original identification information with the purpose of testing whether the atomizer is an original factory product. The step S4 includes steps of: firstly carrying out a match by comparing the identification information and the original identification information stored in memory of the mobile terminal, if the match is unsuccessful, carrying out a match by comparing the identification information and the original identification information stored in cloud server. Such order of matching can accelerate the matching progress.

The step S4 further includes a step of: controlling the battery to wait for use instruction from user so as to supply power to the atomizer when the match is successful. When the match is successful, send an instruction that the match is successful to the battery, and after receiving the instruction, the battery will wait for use instruction from user thereby supplying power to the atomizer. At this point, the user can smoke atomizer directly. The starting of atomizer can be controlled by airflow sensor provided in the atomizer or controlled by switch button provided on the battery, and when using, the user needs to press the switch button for normal use.

The step S4 further includes a step of: giving user a warning that the match is unsuccessful and controlling the battery not to supply power to the atomizer when the match is unsuccessful. When the match is unsuccessful, an instruction that the match is unsuccessful will be sent to the battery and a warning that the match is unsuccessful will be given to user, and the battery will not supply power to the atomizer after receiving the instruction. On this condition, no matter the user how to operate the atomizer, the atomizer receives no power supply from the battery, thus the atomizer can not work. The warning given to user that the authentication is unsuccessful can be achieved in many ways, such as by sending an instruction to make the battery twinkle, providing pop-up dialogs on the mobile terminal and making the screen blink and so on.

After step S4, there is provided a following step:

S5: sending use information of atomizer in real time to the mobile terminal to be stored therein and sending the use information to cloud server as a backup via wireless module, simultaneously. The use information includes the information of frequency of use, duration of use, power, time, date, resistance value of heating wire and taste of the atomizer and so on.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

What is claimed is:

1. A matching device for electronic atomization device based on mobile terminal, comprising:
a Bluetooth control module, provided for building a Bluetooth connection between battery and mobile terminal;
an information reading module, provided for controlling the battery to read identification information of identification chip of atomizer;
an information transmission module, provided for sending the identification information to the mobile terminal via Bluetooth; and
a comparing and matching module, provided for carrying out a match by comparing the identification information and original identification information.

2. The matching device for electronic atomization device based on mobile terminal according to claim 1, wherein the device further comprises a match control module, which is provided for controlling the battery to wait for use instruction from user so as to supply power to the atomizer when the match is successful.

3. The matching device for electronic atomization device based on mobile terminal according to claim 1, wherein the device further comprises a match warning module, which is provided for giving user a warning that the match is unsuccessful and controlling the battery not to supply power to the atomizer when failing to match.

4. The matching device for electronic atomization device based on mobile terminal according to claim 1, wherein said comparing and matching module is provided for firstly carrying out a match by comparing the identification information and the original identification information stored in memory of the mobile terminal, and then carrying out a match by comparing the identification information and the original identification information stored in cloud server if the match is unsuccessful.

5. The matching device for electronic atomization device based on mobile terminal according to claim 1, wherein the device further comprises an information storage module, which is provided for sending the information of frequency, time and date of use of atomizer, which is taken as use information of atomizer, in real time to the mobile terminal to be stored therein, after the match is successful.

6. The matching device for electronic atomization device based on mobile terminal according to claim 5, wherein the storage module is further used for sending the use information to cloud server as a backup via wireless module.

7. A matching method for electronic atomization device based on mobile terminal, comprising following steps:
S1: building a Bluetooth connection between battery and mobile terminal;
S2: reading identification information of identification chip of the atomizer via the battery;
S3: sending the identification information to the mobile terminal via Bluetooth; and
S4: carrying out a match by comparing the identification information and original identification information.

8. The matching method for electronic atomization device based on mobile terminal according to claim 7, wherein the step S4 comprises a step of: controlling the battery to wait for use instruction from user so as to supply power to the atomizer when the match is successful.

9. The matching method for electronic atomization device based on mobile terminal according to claim 7, wherein the step S4 comprises a step of: giving user a warning that the match is unsuccessful and controlling the battery not to supply power to the atomizer when the match is unsuccessful.

10. The matching method for electronic atomization device based on mobile terminal according to claim 7, wherein the step S4 comprises steps of: firstly carrying out a match by comparing the identification information and the original identification information stored in memory of the mobile terminal, if the match is unsuccessful, carrying out a match by comparing the identification information and the original identification information stored in cloud server.

11. The matching method for electronic atomization device based on mobile terminal according to claim 7, wherein the method further comprises a step of:
S5: sending the information of frequency, time and date of use of atomizer, which is taken as use information of atomizer, in real time to the mobile terminal to be stored therein.

12. The matching method for electronic atomization device based on mobile terminal according to claim 11, wherein the step S5 comprises a step of: sending the use information to cloud server as a backup via wireless module, simultaneously.
